(19) United States
(12) Patent Application Publication
(10) Pub. No.: US 2009/0250048 A1
(43) Pub. Date: Oct. 8, 2009

(54) ADJUSTABLE BURNER KIT FOR BARBEQUE GRILLS

(75) Inventors: DAVID EDUCATE, Mequon, WI (US); LADON HOPKINS, Columbus, GA (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: W.C. BRADLEY COMPANY, Columbus, GA (US)

(21) Appl. No.: 12/419,160

(22) Filed: Apr. 6, 2009

Related U.S. Application Data
(60) Provisional application No. 61/042,491, filed on Apr. 4, 2008.

(51) Int. Cl. A47J 37/07; F24C 3/00; F23Q 7/06; B23P 19/04

(52) U.S. Cl. 126/25 R; 126/39 E; 431/258; 29/700

(57) ABSTRACT

An adjustable burner kit for a grill includes an adjustable burner having a burner end telescopically received on a burner inlet. The adjustable burner defines a passageway for receiving gas. The burner inlet has a proximal end for receiving a gas valve. The burner end has a proximal end adjacent to the distal end of the burner inlet. The burner end defines a mounting member on its distal end. The mounting member includes a flat section that defines a cutout for receiving a mounting screw. An optional mount piece may be provided for engaging the mounting member to provide an alternatively oriented mounting interface. The adjustable burner has an adjustable length.

### CROSS REFERENCE TO RELATED APPLICATIONS

This application claims the benefit of and priority to U.S. Provisional Patent Application No. 61/042,491, entitled “ADJUSTABLE BURNER KIT FOR BARBEQUE GRILLS,” filed Apr. 4, 2008, the contents of which are hereby incorporated by reference.

### FIELD OF THE INVENTION

The invention disclosed herein relates to gas-fired barbecue grills and to universal fit replacement burners capable for use in such grills.

### BACKGROUND OF THE INVENTION

Gas-fired barbecue grills continue to increase in popularity due to their convenience of operation, relatively instant availability for use in cooking, and design improvements that facilitate their assembly and use.

Gas-fired barbecue grills are typically constructed of exterior components, including a bottom and top casting, that can exhibit a lengthy useful life despite being exposed to the weather. However, various other components of a typical gas-fired barbeque grill have a shorter useful life. For example, burner elements, which are mounted within the interior of the grill for distributing gas from the fuel tank for burning, may corrode or otherwise become degraded in just a few years.

Due to the relatively short useful life of the burner elements, replacement grill parts are available for purchase so that consumers can replace various components of their grills when necessary. However, the availability of a universal fit burner element is problematic due to the different sizes and shapes of components employed in various grills on the market.

### SUMMARY OF THE INVENTION

A universal fit adjustable burner kit is described herein. The kit includes a burner element having telescoping sections for adjusting a length of the burner element. The kit includes a burner mounting bracket piece, which may be used or omitted depending on the particular configuration of the grill. An electrode for igniting gasses emanating from the burner element may be mounted to the burner element using an electro-mount bracket. Additionally, the burner element may protrude out of the bottom casting or firebox, thereby allowing for additional adjustability and easy access for mounting valves onto the burner ends.

### BRIEF DESCRIPTION OF THE DRAWINGS

FIG. 1 is a perspective view of a grill having replacement burner elements installed therein;

FIG. 2A is a side view of the burner element of the invention shown in a disassembled configuration;

FIG. 2B is a side view of the burner element of the invention shown in an assembled configuration;

FIG. 3 is an enlarged perspective view showing the burner element passing through a hole in a grill body having an electrode attached;

FIG. 4 is an enlarged perspective view of a burner end with a firebox mating bracket;

FIG. 5 is a perspective view of the components of the present invention in a disassembled state; and

FIG. 6 is a perspective view of the various components in an assembled state.

### DETAILED DESCRIPTION OF THE PREFERRED EMBODIMENTS

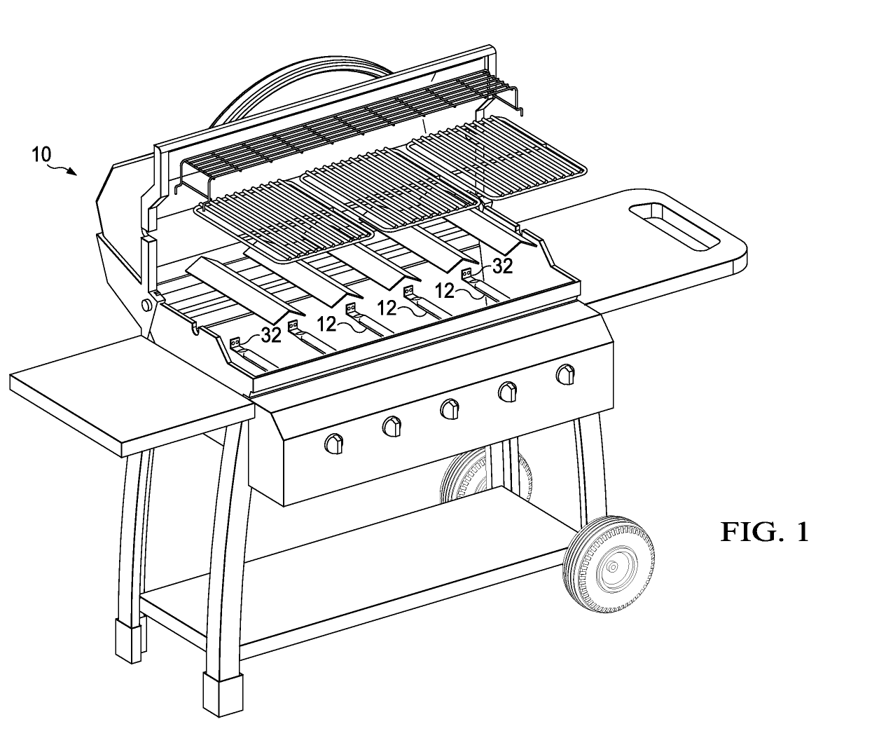

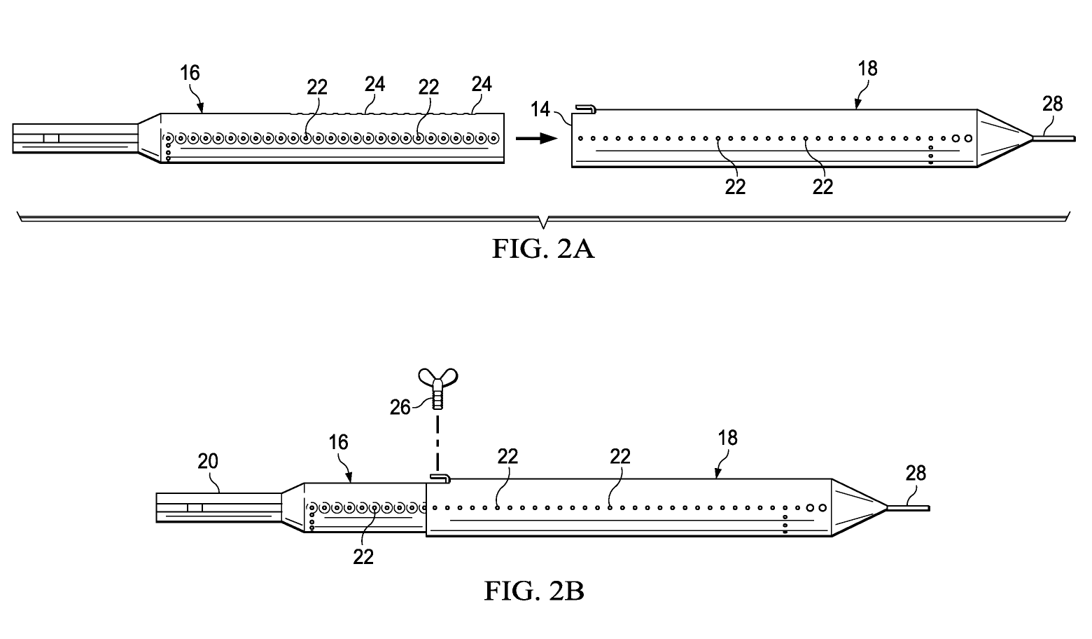

Referring now to FIG. 1, grill 10 is shown with a plurality of replacement burners 12 installed therein. Each burner 12 of the invention is a telescoping burner that defines passageway 14. Telescoping burner 12 has a burner inlet 16 and a burner end 18 (see, e.g., FIGS. 2A, 2B). Burner inlet 16 defines a proximal end that defines a narrow section 20. Burner inlet 16 and burner end 18 each define a plurality of gas orifices 22. On burner inlet 16, gas orifices 22 are each surrounded by a conical detent area that may be formed by nail punching. The recessed area facilitates improved gas flow out of orifices 22 in burner end 18. Burner inlet 16 additionally defines a plurality of adjustment detents 24 for receiving an adjustment screw 26 (FIG. 2B).

Burner end 18 has a proximal end that is received on distal end of burner inlet 16. Burner end 18 defines a screw receptacle for receiving adjustment screw 26 for securing burner inlet 16 and burner end 18 in a desired relationship. Burner end 18 preferably defines a flattened end or mounting member 28, that extends from the distal end of burner end 18. Mounting member 28 defines a plurality of slots for receiving a vertical burner screw 30 (FIG. 4) to be threaded into the firebox of grill 10. By providing a plurality of slots on mounting member 28, various firebox configurations may be accommodated. A supplemental firebox mount piece 32 is provided for affixing to mounting member 28, if necessary, to provide an alternative vertically oriented mounting interface. In similar fashion, a plurality of slots is provided on mount piece 32 to receive horizontal mounting screw 34 to be threaded into the firebox of grill 10.

Mounting piece 32 may be used or may be omitted, depending upon the geometry of the firebox of grill 10 into which burner 12 is to be installed, to facilitate mounting of the telescoping burner 12 in proper position for operation.

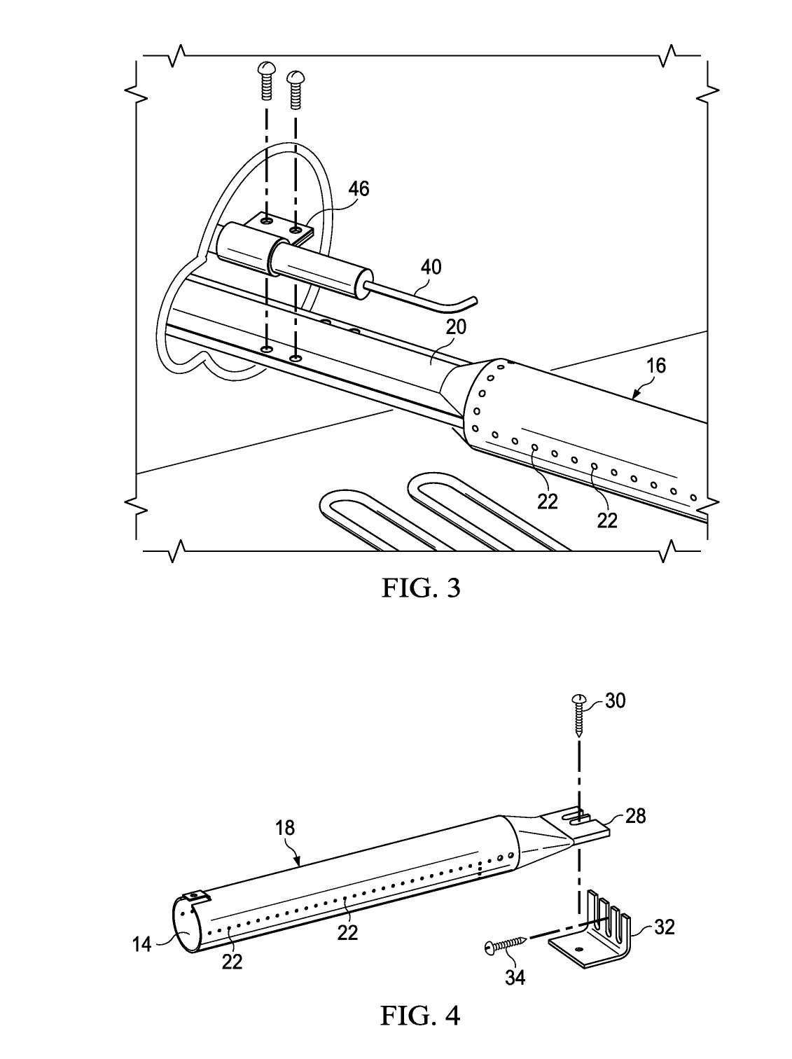

An electrode 40 (FIG. 3) is typically used to provide a spark to ignite gases. In a preferred embodiment, a side electrode mounting bracket 46 may be affixed to left or right flattened areas of burner inlet 16 for attaching electrode 40.

Conventional fasteners are used to connect the various components of the present invention. Preferably, screw 30 is used to secure mount piece 32 to mounting member 28. Other means of fastening may also be used.

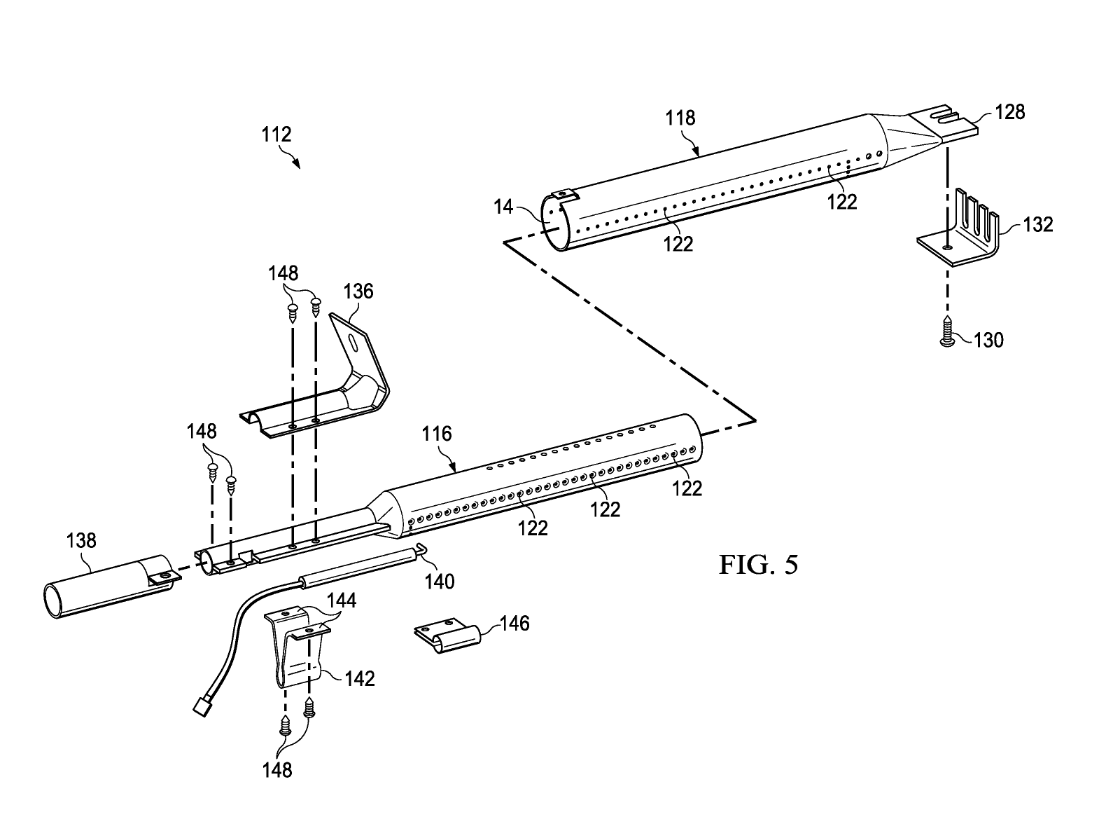

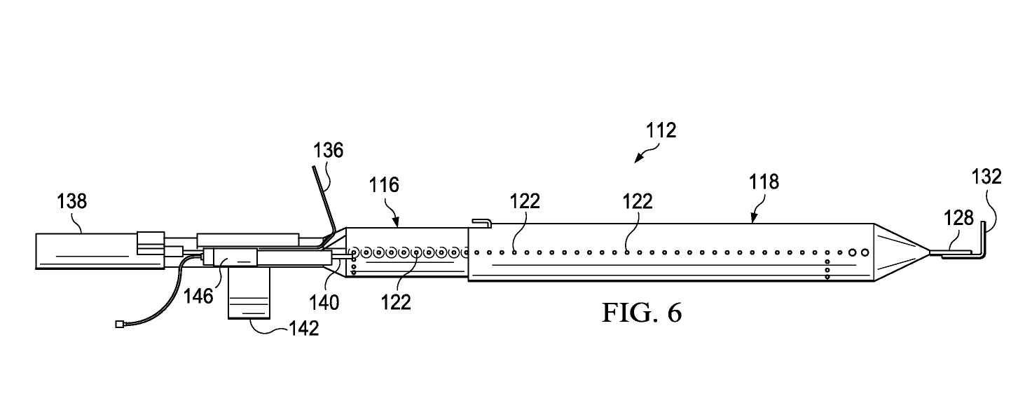

Referring now to FIGS. 5 and 6, burner 112 of the invention is a telescoping burner having multiple mounting options. Telescoping burner 112 has an adjustable burner inlet 116 and an adjustable burner end 118. Adjustable burner inlet 116 defines a plurality of gas orifices 122. In burner inlet 116, gas orifices 122 are each surrounded by a conical detent area that may be formed by nail punching. The recessed area facilitates improved gas flow out of orifices 122 in burner end 118.

Adjustable burner end 118 is preferably provided with a mounting member 128 that extends from the distal tip of burner end 118. Mounting member 128 is provided with a plurality of slots for receiving a screw 130 to be threaded into a firebox. By providing a plurality of slots, various firebox configurations may be accommodated. To accommodate still other firebox configurations found in the marketplace, a supplemental firebox mount piece 132 is provided for affixing to mounting member 128, if necessary, to provide an alternative vertically oriented mounting interface. In similar fashion, a plurality of slots is provided on mount piece 132 to receive a mounting screw to be threaded into a firebox.

To facilitate mounting in certain firebox configurations, an upper mount bracket 136 is affixed to an upper surface proximate a base end of adjustable burner inlet 116. Mount bracket 136 preferably has a shaped horizontal section for mating engagement with a shaped section of adjustable burner inlet 116. A vertical section is provided with an orifice to facilitate screw attachment to a firebox or grill apparatus. In addition, an air inlet extension 138 is provided for affixing to a base end of adjustable burner inlet 116.

As can been seen, the aforedescribed cooperative mounting pieces may be used individually or in any combination of two pieces or three pieces, depending upon the geometry of the grill into which burner 112 is to be installed, to facilitate mounting of the telescoping burner in proper position for operation.

An electrode 140 is typically used to provide a spark to ignite gases. For retrofitting grills that require a bottom mounted electrode, an electro-mount bracket 142 is secured to a lower surface proximate base end of adjustable burner inlet 116. Electro-mount bracket 142 is preferably approximately V-shaped, having flange members 144 on an upper end thereof to facilitate attachment to lateral extensions on burner inlet 116.

For grill configurations that require a side mounted electrode 140, a side electrode mounting bracket 146 may be affixed to burner inlet 116 for attaching electrode 140.

Conventional fasteners are used to connect the various components of the present invention. Preferably, pan head screw 130 is used to secure mount piece 132 to mounting member 128. Sheet metal screws 148 may be used to secure electro-mount bracket 142, side electrode mounting bracket 146, air inlet extension 138 and mount bracket 136. Other means of fastening are acceptable.

One advantage of the adjustable burner package of the present invention is that mounting bracket pieces are provided so that, alone or in combination, the adjustable burner of the invention can be installed in most existing grills.

Another advantage of the telescoping burner 12, 112 is that burner end 18, 118 may be adjusted with regard to burner inlet 16, 116 to vary the length of telescoping burner 12, 112 to fit within a particular firebox of an existing grill. Further adjustability is achieved by extending air inlet extension 138 such that telescoping burner 112 protrudes through an orifice in a firebox wall or grill 10.

While two embodiments of an adjustable burner for barbecue grills and other gas appliances and modifications thereof have been shown and described in detail herein, various additional changes and modifications may be made without departing from the scope of the present invention.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art.

What is claimed is:

1. An adjustable burner kit for a grill comprising:
an adjustable burner having a burner end telescopically received on a burner inlet;
said burner end and said burner inlet defining a passageway;
said burner inlet having a proximal end and a distal end, said proximal end for receiving a gas valve;
said burner end having a distal end and a proximal end, said proximal end of said burner end adjacent said distal end of said burner inlet, said burner end defining a mounting member on said distal end;
a mount piece for engaging said mounting member of said burner end for providing an alternatively oriented mounting interface;
an electrode mounting bracket adjacent to said burner inlet for igniting gasses within said adjustable burner;
wherein said adjustable burner has an adjustable length.

2. The adjustable burner kit for a grill according to claim 1 wherein:
said mounting member comprises a flat section defining a cutout for receiving a mounting screw.

3. The adjustable burner kit for a grill according to claim 2 wherein said mounting member defines a plurality of cutouts to facilitate attachment to various grill configurations.

4. The adjustable burner kit for a grill according to claim 1 wherein said mount piece defines a cutout for receiving a mounting screw.

5. The adjustable burner kit for a grill according to claim 4 wherein said mount piece defines a plurality of cutouts to facilitate attachment to various grill configurations.

6. The adjustable burner kit for a grill according to claim 1 further comprising:
an electrode affixed by said electrode mounting bracket adjacent to said burner inlet for igniting gasses within said adjustable burner.

7. The adjustable burner kit for a grill according to claim 1 further comprising:
an optional mount bracket for affixing to an upper side of said adjustable burner, said mount bracket having a horizontal section for affixing to said burner inlet and having a vertical section to facilitate attachment to a firebox or grill apparatus.

8. The adjustable burner kit for a grill according to claim 1 further comprising:
an air extension for affixing to said proximal end of said burner inlet.

9. A method of installing a replacement burner in a grill with an adjustable burner kit comprising the steps of:
locating an adjustable burner within a grill body, said adjustable burner having a burner end telescopically received on a burner inlet;
adjusting a length of said adjustable burner by sliding said burner end on said burner inlet to lengthen or shorten said adjustable burner as desired;
affixing said burner inlet to a gas valve;
determining whether a mounting member on said burner end can be affixed to a horizontal surface in said grill body;
adding a mount piece to said burner end for engaging said mounting member of said adjustable burner to provide an alternatively oriented mounting interface for engaging said grill body; and
locating an electrode within a mounting bracket adjacent to said burner inlet for igniting gasses within said adjustable burner.

10. The method according to claim 9 further comprising the steps of:
affixing an upper mount bracket to an upper side of said adjustable burner, wherein said upper mount bracket has a horizontal section for affixing to said burner inlet and has a vertical section to facilitate attachment to said grill body or grill apparatus.
